(19) United States
(12) Patent Application Publication
(10) Pub. No.: US 2010/0222540 A1
(43) Pub. Date: Sep. 2, 2010

(54) NCO-FUNCTIONAL PREPOLYMER MADE OF DICYCLOHEXYL METHANE DIISOCYANATE, ISOPHORONE DIISOCYANATE, AND POLYETHER POLYOLS, HAVING A REDUCED TENDENCY TO CRYSTALLIZATION

(75) Inventors: Andre Raukamp, Rosendahl-Holtwick (DE); Dirk Hoppe, Nottuln (DE); Christoph Nacke, Schermbeck (DE); Rainer Lomoelder, Muenster (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essex (DE)

(21) Appl. No.: 12/682,042

(22) PCT Filed: Sep. 25, 2008
(86) PCT No.: PCT/EP08/62810

§ 371 Date: Apr. 8, 2010

(30) Foreign Application Priority Data
Nov. 10, 2007 (DE) 102007053687.0

(51) Int. Cl. C08G 18/32

(52) U.S. Cl. 528/66

(57) ABSTRACT

The invention relates to NCO-functional prepolymers prepared from dicyclohexylmethane diisocyanate (H₁₂MDI hereinafter) and polyether polyols, with a reduced tendency to crystallization, a fraction of the H₁₂MDI being blended with further monomeric isophorone diisocyanate (IPDI hereinafter), so making it possible to reduce or prevent entirely the tendency to crystallization, and also to the preparation and use.

The invention relates to NCO-functional prepolymers prepared from dicyclohexylmethane diisocyanate (H₁₂MDI hereinafter) and polyether polyols, with a reduced tendency to crystallization, a fraction of the H₁₂MDI being blended with further monomeric isophorone diisocyanate (IPDI hereinafter), so making it possible to reduce or prevent entirely the tendency to crystallization, and also to the preparation and use.

NCO-functional polyurethane prepolymers are well established [Polyurethane für Lacke und Beschichtungen, Dr. Manfred Bock, 1999, 23 ff, 157ff]. In combination with, for example, polyamines or polyols, they can be used for high molecular mass polymers for the production of coatings, adhesives, elastomers and casting resins, or else may be employed as moisture-curing 1-component systems.

The production of NCO-functional polyurethane prepolymers is carried out with an excess of monomeric diisocyanates. Via the stoichiometric ratio it is possible to tailor the physical and chemical properties of the prepolymer, such as viscosity and NCO number. These properties are important more particularly for the use of these prepolymers as a crosslinker component for casting resin systems which are processed by means of 2-component mixing units.

Through a targeted selection of the polyether polyol for the prepolymerization of H₁₂MDI it is possible to harmonize the viscosity of the prepolymer with that of the polyol and hence to achieve a homogeneous mixing operation. Since 2-component mixing units often do not allow variable adjustment of the mixing ratio, it is possible, by setting an NCO number of the prepolymer that corresponds to the OH number of the polyol, to bring about stoichiometric mixing of the components.

Prepolymers based on H₁₂MDI, however, often tend towards hazing as a result of partial crystallization during storage, and must be pretreated (homogenized) by means of temperature prior to use.

An object of this invention was to reduce this crystallization tendency and at the same time to retain the effective weathering stability of H₁₂MDI-based systems.

The inventive achievement of this object lies in using mixtures of H₁₂MDI with 3-isocyanatomethyl-3,5,5-trimethylcyclohexyl isocyanate (isophorone diisocyanate hereinafter, abbreviated to IPDI) for the prepolymerization.

The invention provides an NCO-functional polyurethane prepolymer having an NCO functionality of 2 and an NCO content of 5%-30% by weight, comprising
A) 20%-80% by weight dicyclohexylmethane diisocyanate (H₁₂MDI),
B) 5%-20% by weight isophorone diisocyanate (IPDI),
C) 5%-75% by weight at least one polyether polyol having a functionality of 2 to 5, an OH number of 20 to 800 mg KOH/g and an average molecular weight Mw of 200 to 8000 g/mol.

The particular value of these formulations lies in the ease of handling of these systems with retention of the elastomer properties through a targeted selection of the isocyanate mixture for the purpose of preventing the crystallization tendency.

The NCO-functional polyurethane prepolymers of the invention are compounds prepared by reacting monomeric diisocyanates superstoichiometrically with polyfunctional polyether polyols.

As component A) it is possible in principle to use all isomers of H₁₂MDI, namely 2,2′- and 2,4′- and 4,4′-dicyclohexylmethane diisocyanate, alone or in mixtures. The H₁₂MDI is preferably composed of at least 80% by weight of 4,4′-H₁₂MDI, preferably of 85%-95% by weight, and of 5% to 20% by weight, preferably 7%-15% by weight, of 2,4′-H₁₂MDI. The H₁₂MDI preferably includes a small fraction of 2,2′-H₁₂MDI of less than 5% by weight, preferably less than 1% by weight. The trans,trans content of the 4,4′-H₁₂MDI is less than 30%, preferably from 5% to 25%.

B) As component B) use is made of 3-isocyanatomethyl-3,5,5-trimethylcyclohexyl isocyanate (isophorone diisocyanate hereinafter, abbreviated to IPDI).

The polyether polyols C) are polyalkoxyalkylenes having terminal OH groups. They are obtained by addition reaction of cyclic ethers such as ethylene oxide and/or, more frequently, propylene oxide with difunctional starter molecules. If the latter are blended with trifunctional starters, branched reaction products can also be obtained. Starter molecules used are generally polyhydric alcohols such as ethylene glycol, 1,2-propanediol, trimethylolpropane, glycerol or sugars. For specific applications there are also tetrafunctional polyethers available that are prepared starting from aliphatic diamines.

Preferred polyether polyols have 2-5, more preferably 2-3, OH groups per molecule. These groups may be primary or secondary.

Preferred alcohols are ethylene glycol, 1,2-propanediol, trimethylolpropane, glycerol and pentaerythritol. Preferred alkylene oxides are ethylene oxide and propylene oxide. Mixtures can be used as well.

The OH number is 20 to 800 mg KOH/g, preferably 30 to 200 mg KOH/g. The molecular weight M_{w} is 200-8000, preferably 500-6000 g/mol.

Examples of suitable polyether polyols that can be used include VORANOL CP 4755, VORANOL CP 3355 (DOW Chemical Company), or else POLY G-30-400 T (Arch Chemicals, Inc.).

These polyurethane prepolymers of the invention have an NCO functionality of ≧2, preferably of 2 to 3. The NCO content (measured in accordance with DIN EN ISO 11909) is 5% to 30% by weight, preferably 10% to 25% by weight. They additionally have a viscosity at 23° C. of 100 mPas to 2500 mPas (measured in accordance with DIN EN ISO 3219).

The invention further provides a process for preparing an NCO-functional polyurethane prepolymer having an NCO functionality of ≧2 and an NCO content of 5%-30% by weight, comprising
A) 20%-80% by weight dicyclohexylmethane diisocyanate (H₁₂MDI),
B) 5%-20% by weight isophorone diisocyanate (IPDI),
C) 5%-75% by weight at least one polyether polyol having a functionality of 2 to 5, an OH number of 20 to 800 mg KOH/g and an average molecular weight Mw of 200 to 8000 g/mol,
   by reaction of components A) and B) with C).

The prepolymers of the invention are prepared by reaction of components A) and B) with the polyether polyol C) at about 60° C. The components A) and B) may be reacted simultaneously with component C). An alternative option is to react the components individually with component C) and then to mix the two prepolymers thus obtained to give the polyurethane prepolymer of the invention. For this purpose it is common to use metal catalysts in order to reduce the operating times. Aminic catalysts as well are suitable in principle, however. Examples of suitable catalysts are dibutyltin dilaurate or dibutyltin diacetate.

The invention also provides for the use of the polyurethane prepolymers of the invention as moisture-curing binders, or as crosslinkers of polyfunctional polyols, or else of other products reactive towards isocyanate groups, more particularly in 2-component polyurethane systems, and more particularly of coatings, adhesives, elastomers and casting resins.

Likewise provided by the invention are coatings, adhesives, elastomers, casting resins, 2-component polyurethane systems, coated articles and articles which contain the polyurethane prepolymers of the invention. The polyfunctional polyols which are used for this purpose and are reactive with the prepolymer of the invention generally have an OH number of 5-400 mg KOH/g. Suitability is possessed by polyether polyols, polycaprolactones, polytetramethylene glycol, polyacrylate polyols, polycarbonate polyols and polyester polyols.

Suitable polyester polyols include all polycondensation products formed from an excess of low molecular mass, polyfunctional alcohols with polyhydric carboxylic acids and/or their anhydrides.

Polycaprolactones are polymerization products of caprolactone in the presence of an alcohol or a diol.

Polytetramethylene glycol comprises polymers of tetrahydrofuran.

Polycarbonate polyols are polymers of macrocyclic carbonic diesters.

Polyacrylate polyols are polymers formed from derivatives of acrylic and methacrylic acid, principally the esters.

Additionally it is possible for stabilizers to be employed for the purpose of improving the light stability and ageing resistance.

The invention is illustrated below by means of examples.

### EXAMPLES

The example formulations which follow have an NCO number of around 16% by weight. Preparation took place in a stirred, three-necked flask apparatus, using dry nitrogen with a purity of 99.999%. The ingredients of the formulation were introduced and heated to 60° C. When the theoretical NCO number was attained, cooling was carried out at ambient temperature to room temperature.

Formulation for comparison:

54.67% by weight H₁₂MDI
45.30% by weight VORANOL CP 4755, Mw: 5000; OH number: 35 mg KOH/g; functionality: 3
0.03% by weight dibutyltin dilaurate (DBTDL)

### Inventive, Crystallization-Stable Formulation I

42.30% by weight H₁₂MDI
10.60% by weight IPDI
47.07% by weight VORANOL CP 4755
0.03% by weight dibutyltin dilaurate (DBTDL)

### Inventive, Crystallization-Stable Formulation II

36.45% by weight H₁₂MDI
15.62% by weight IPDI
47.90% by weight VORANOL CP 4755
0.03% by weight dibutyltin dilaurate (DBTDL)

### Properties of Crystallization-Stable Formulations I+II

NCO content (DIN EN ISO 11909): about 16% by weight
Viscosity (DIN EN ISO 3219): about 250 mPas
Appearance (visual): clear
Functionality (numerical average, about 2.1 theoretical):

It was found that the crystallization of the polyurethane prepolymers is quicker at low temperatures, and so all of the resulting prepolymers were stored at 4° C. and subjected to daily inspection.

In accordance with the method stated above, all of the formulations were tested daily for crystallization phenomena. The table which follows indicates the time in days for which the respective formulation showed no signs at all of crystallization.

| | Crystallization stability |
|---|---|
| | time in days |
| Formulation for comparison | 1-3 |
| Formulation I | 90 |
| Formulation II | >90 |

### Use Examples

The formulations were processed to a casting resin and to that end were reacted with a polyether polyol.

Crosslinking took place stoichiometrically with a polyether polyol which had
an OH number of about 400 mg KOH/g and the following additions:
2% HALS (Hindered Amine Light Stabilizer)
2% benzotriazole-based UV absorber
0.2% BYK 070 (defoamer)
0.1% COSCAT 83 (catalyst)

The light stability of the above formulations was assessed by accelerated weathering in accordance with ISO 4892-3 (QUV-B).

For this purpose, cast plates with a thickness of about 1 mm were subjected for 1000 hours to the following continuous weathering cycle:
4 hours' UV-B with a surface temperature of about 55° C.
4 hours' condensation with a surface temperature of about 45° C.

The UV-B tubes used had an intensity of 0.8 watts/m² (measured at a wavelength of 313 nm).

The table which follows shows the degree of yellowing. This was done by determination of the b value in accordance with ISO 7724-3.

| | Δb |
|---|---|
| | [b (after weathering) − b |
| | (before weathering)] |
| Formulation for comparison | 2.74 |
| Formulation I | 2.92 |
| Formulation II | 2.72 |

All of the formulations showed a comparable level of yellowing.

1. An NCO-functional polyurethane prepolymer having an NCO functionality of ≧2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.

2. The NCO-functional polyurethane prepolymer according to claim 1, wherein it has a viscosity at 23° C. of 100 mPas to 2500 mPas (measured in accordance with DIN EN ISO 3219).

3. The NCO-functional polyurethane prepolymer according to claim 1, wherein component A) is composed of 75%-95% by weight of 4,4′-H₁₂MDI with a trans,trans content of less than 30%.

4. The NCO-functional polyurethane prepolymer according to claim 1, wherein polyether polyols C) from alcohols selected from ethylene glycol, 1,2-propanediol, trimethylolpropane, glycerol and/or pentaerythritol and ethylene oxide and/or propylene oxide are present.

5. The NCO-functional polyurethane prepolymer according to claim 1, wherein the polyether polyols C) have 2-5 OH groups per molecule and an Mw of 500 to 6000 g/mol.

6. A process for preparing an NCO-functional polyurethane prepolymer having an NCO functionality of ≧2 and an NCO content of 5%-30% by weight, which prepolymer comprises
A) 20%-80% by weight dicyclohexylmethane diisocyanate (H₁₂MDI),
B) 5%-20% by weight isophorone diisocyanate (IPDI),
C) 5%-75% by weight at least one polyether polyol having a functionality of 2 to 5, an OH number of 20 to 800 mg KOH/g and an average molecular weight Mw of 200 to 8000 g/mol,
by reaction of components A) and B) with C).

7. A method for producing a coating adhesive, elastomer, casting resin or 2-component polyurethane system which comprises using an NCO-functional polyurethane prepolymer having an NCO functionality of ≧2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.

8. A coating containing an NCO-functional polyurethane prepolymer having an NCO functionality of 2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.

9. An adhesive containing an NCO-functional polyurethane prepolymer having an NCO functionality of ≧2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.

10. An elastomer containing an NCO-functional polyurethane prepolymer having an NCO functionality of ≧2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.

11. A casting resin containing an NCO-functional polyurethane prepolymer having an NCO functionality of 2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.

12. A two-component polyurethane system containing an NCO-functional polyurethane prepolymer having an NCO functionality of 2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.

13. An article which contains an NCO-functional polyurethane prepolymer having an NCO functionality of 2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.

14. An article coated with an NCO-functional polyurethane prepolymer having an NCO functionality of ≧2 and an NCO content of 5%-30% by weight, comprising
A) 20%-80% by weight dicyclohexylmethane diisocyanate (H₁₂MDI),
B) 5%-20% by weight isophorone diisocyanate (IPDI), and
C) 5%-75% by weight at least one polyether polyol having a functionality of 2 to 5, an OH number of 20 to 800 mg KOH/g and an average molecular weight Mw of 200 to 8000 g/mol.
